(19) United States
(12) Patent Application Publication
(10) Pub. No.: US 2021/0248463 A1
(43) Pub. Date: Aug. 12, 2021

(54) NEURAL NETWORK DERIVATION METHOD

(71) Applicant: SOCIONEXT INC., Kanagawa (JP)

(72) Inventor: Yukihiro SASAGAWA, Yokohama (JP)

(21) Appl. No.: 17/165,322

(22) Filed: Feb. 2, 2021

(30) Foreign Application Priority Data
Feb. 6, 2020 (JP) 2020-018469
Nov. 16, 2020 (JP) 2020-190347

(51) Int. Cl. G06N 3/08; G06N 3/04; G06K 9/62

(52) U.S. Cl. CPC G06N 3/08; G06K 9/6215; G06K 9/6257; G06N 3/0454

(57) ABSTRACT

A neural network derivation method includes: (1) training a first neural network having a first parameter, using a first loss function for optimization; and (2) training the first neural network using a second loss function for optimization, after (1), the second loss function being obtained by adding a regularization term to the first loss function. After a second neural network having a second parameter obtained by adding a variation to the first parameter based on the first neural network is derived, the regularization term is determined based on a correlation between a latent feature of the first neural network and a latent feature of the second neural network or a correlation between an inferred value of the first neural network and an inferred value of the second neural network.

### CROSS REFERENCE TO RELATED APPLICATIONS

The present application is based on and claims priority of Japanese Patent Application No. 2020-018469 filed on Feb. 6, 2020 and Japanese Patent Application No. 2020-190347 filed on Nov. 16, 2020. The entire disclosure of the above-identified applications, including the specifications, drawings and claims is incorporated herein by reference in its entirety.

### FIELD

The present disclosure relates to a neural network derivation method for deriving a neural network.

### BACKGROUND

An inference model including a neural network is used to identify or classify inputted data. Patent Literature (PTL) 1 discloses, as an example of a method of generating this inference mode, a method of training a neural network with a training data set to generate an inference model.

### CITATION LIST

### Patent Literature

PTL 1: Japanese Unexamined Patent Application Publication (Translation of PCT Application) No. 2018-525734

### SUMMARY

### Technical Problem

When an inference mode is actually used, an incorrect inferred value may be outputted by a parameter of a neural network or input data inputted to the neural network varying.

The present disclosure has been made in view of the above problem and has an object to provide a neural network derivation method for deriving a neural network having robustness to a variation in parameter or input data of the neural network.

### Solution to Problem

In order to achieve the above object, a neural network derivation method according to one aspect of the present disclosure includes: (1) training a first neural network having a first parameter, using a first loss function for optimization; and (2) training the first neural network using a second loss function for optimization, after (1), the second loss function being obtained by adding a regularization term to the first loss function. After a second neural network having a second parameter obtained by adding a variation to the first parameter based on the first neural network is derived, the regularization term is determined based on a correlation between a latent feature of the first neural network and a latent feature of the second neural network or a correlation between an inferred value of the first neural network and an inferred value of the second neural network.

In order to achieve the above object, a neural network derivation method according to one aspect of the present disclosure includes: (1) training a first neural network having a first weight parameter, using a first loss function for optimization; and (2) training the first neural network using a second loss function for optimization, after (1), the second loss function being obtained by adding a regularization term to the first loss function. The regularization term is determined based on a relationship between the first neural network and a second neural network having a second weight parameter obtained by adding a variation to the first weight parameter based on the first neural network.

In order to achieve the above object, a neural network derivation method according to one aspect of the present disclosure includes: (1) training a first neural network having a first parameter, using a first loss function for optimization; and (2) training the first neural network using a second loss function for optimization, after (1), the second loss function being obtained by adding a regularization term to the first loss function. The regularization term is determined based on a relationship between the first neural network and a second neural network based on the first neural network. The second neural network is based on the first neural network and further includes a configuration in which an input of at least one layer is obtained by adding a variation to a feature that is an output of a preceding layer.

In order to achieve the above object, a neural network derivation method according to one aspect of the present disclosure includes: (1) training a first neural network to which first input data is inputted, using a first loss function for optimization; and (2) training the first neural network using a second loss function for optimization, after (1), the second loss function being obtained by adding a regularization term to the first loss function. After a second neural network to which second input data obtained by adding a variation to the first input data based on the first neural network is inputted is derived, the regularization term is determined based on a time-series variation in similarity between a fifth inferred value of the first neural network and a sixth inferred value of the second neural network.

It should be noted that these general or specific aspects may be implemented by a system, a method, an integrated circuit, a computer program, or a non-transitory computer-readable recording medium such as a compact disc read only memory (CD-ROM), or by any combination of systems, methods, integrated circuits, computer programs, or recording media.

### Advantageous Effects

The present disclosure makes it possible to derive a neural network having robustness to a variation in parameter or input data of the neural network.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram schematically illustrating a change in accuracy of an inferred value when a weight parameter of a neural network varies.

FIG. 2 is a schematic diagram illustrating a function of a discriminator that determines the accuracy of an inferred value.

FIG. 3 is a flowchart illustrating an outline of a neural network derivation method.

FIG. 4 is a diagram illustrating a derivation model for deriving a neural network in Embodiment 1.

FIG. 5 is a flowchart illustrating a neural network derivation method according to Embodiment 1.

FIG. 6 is a flowchart illustrating a neural network derivation method executed following FIG. 5.

FIG. 7 is a schematic diagram illustrating a discrimination training model included in the derivation model shown by FIG. 4.

FIG. 8 is a diagram illustrating an example of the hardware configuration of a computer that implements, using software, the functions of an apparatus that executes the neural network derivation method according to Embodiment 1.

FIG. 9 is a diagram illustrating a derivation model for deriving a neural network in Embodiment 2.

FIG. 10 is a flowchart illustrating a neural network derivation method according to Embodiment 2.

FIG. 11 is a flowchart illustrating a neural network derivation method executed following FIG. 10.

FIG. 12 is a schematic diagram illustrating a discrimination training model included in the derivation model shown by FIG. 9.

FIG. 13 is a diagram illustrating a derivation model for deriving a neural network in Embodiment 3.

FIG. 14 is a flowchart illustrating a neural network derivation method according to Embodiment 3.

FIG. 15 is a flowchart illustrating a neural network derivation method executed following FIG. 10.

FIG. 16 is a schematic diagram illustrating a discrimination training model included in the derivation model shown by FIG. 13.

FIG. 17 is a diagram illustrating a derivation model for deriving a neural network in Embodiment 4.

FIG. 18 is a flowchart illustrating a neural network derivation method according to Embodiment 4.

FIG. 19 is a diagram illustrating the definition of a feature similarity in Embodiment 4.

### DESCRIPTION OF EMBODIMENTS

### (Circumstances Leading to the Present Disclosure)

An inference model trained through machine learning has been increasingly mounted on a large-scale integrated circuit (LSI). Generally, a weight parameter expressed by a real-valued representation is used at the time of training, but a weight parameter obtained by quantizing (discretizing) a weight parameter at the time of training to a fixed-point representation etc. is used at the time of mounting. Although it is possible to reduce hardware costs at the time of mounting, by using a quantized weight parameter, the accuracy of an inferred value in an inference model may decrease due to a quantization error.

The following has been published: a method of intentionally adding noise to input data of a trained inference model and causing the inference model to make an incorrect inference. For example, in “DEFENSIVE QUANTIZATION: WHEN EFFICIENCY MEETS ROBUSTNESS, ICLR 2019,” it is stated that quantization reduces resistance to adversarial attacks (attacks by adversarial samples) significantly.

In view of the above, there has been a demand for an inference model having robustness such that the accuracy of an inferred value is less susceptible to such a variation in weight parameter and input data. Hereinafter, in order to facilitate understanding, description is provided focusing on a weight parameter out of a weight parameter and input data.

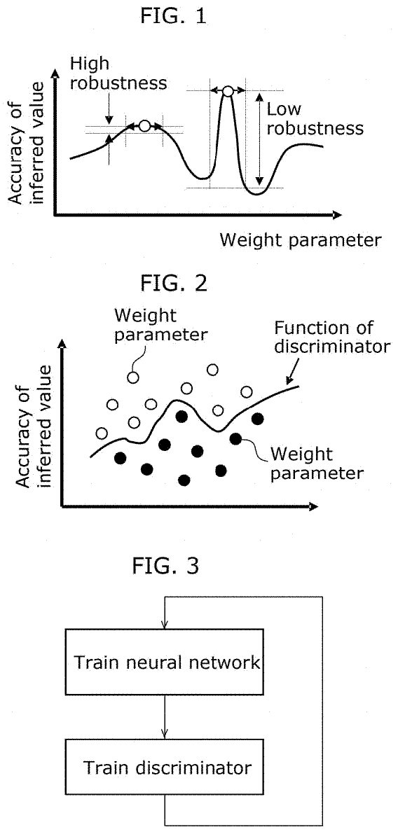

FIG. 1 is a diagram schematically illustrating a change in accuracy of an inferred value when a weight parameter of a neural network varies. The right part of FIG. 1 shows an example in which the accuracy of an inferred value changes significantly as a weight parameter varies. The left part of FIG. 1 shows an example in which the accuracy of an inferred value does not change significantly even when a weight parameter varies. In the context of the robustness of an inference model, as shown by the left part of FIG. 1, it is desirable that the accuracy of an inferred value do not decrease easily even when a weight parameter varies.

For example, when a neural network is trained using only a loss function for optimization, an inference model having low robustness may be generated as shown by the right part of FIG. 1. For this reason, in the present disclosure, when an inference model is generated, training is performed using a loss function for optimization to which a regularization term is added. This regularization term prevents a weight parameter used by a neural network from becoming a weight parameter likely to change the accuracy of an inferred value. For example, in the present disclosure, when a neural network is trained, a weight parameter is updated so that a value of “loss function+regularization term” becomes smaller, and an inference model is generated. Accordingly, even when a weight parameter is quantized at the time of mounting, it is possible to reduce a significant decrease in accuracy of an inferred value.

The regularization term in above “loss function+regularization term” is determined to be larger when the accuracy of an inferred value decreases, and is determined to be smaller when the accuracy of an inferred value increases. The following describes how to determine whether the accuracy of an inferred value is to increase or decrease.

FIG. 2 is a schematic diagram illustrating a function of a discriminator that determines the accuracy of an inferred value. FIG. 2 shows a state in which weight parameters that decrease the accuracy of an inferred value when the weight parameters are quantized (the lower region of FIG. 2) and weight parameters that are less likely to decrease the accuracy of an inferred value even when the weight parameters are quantized (the upper region of FIG. 2) are classified by the function of the discriminator. When such a discriminator can be generated, it is possible to determine whether an unknown weight parameter is to decrease the accuracy of an inferred value, and it is possible to decide whether to increase or decrease a regularization term based on the determination result.

FIG. 3 is a flowchart illustrating an outline of a neural network derivation method. In the present disclosure, first, a neural network is trained using a training data set. Next, a discriminator is trained using a weight parameter of the neural network, and the discriminator is generated. Then, a regularization term is derived from the discriminator, and the neural network is trained again using “loss function+regularization term” for optimization in which the regularization term is reflected. Finally, an inference model is generated by repeating the training of the neural network and the training of the discriminator. The neural network derivation method makes it possible to derive a neural network having robustness to a variation in weight parameter.

Hereinafter, embodiments of the present disclosure will be described in detail with reference to the drawings. It should be noted that each of the embodiments described below shows a general example of the present disclosure. The numerical values, shapes, materials, standards, elements, the arrangement and connection of the elements, steps, the order of the steps, etc. shown in the following embodiments are mere examples, and therefore are not intended to limit the present disclosure. Among the elements described in the following embodiments, elements not recited in any one of the independent claims that indicate the broadest concepts of the present disclosure are described as optional elements. The respective figures are schematic diagrams and are not necessarily precise illustrations. In each of the figures, substantially identical elements are assigned the same reference signs, and overlapping description may be omitted or simplified.

### Embodiment 1

### [1-1. Derivation Model for Deriving Neural Network]

First, the following describes a derivation model for deriving a neural network having robustness to a variation in parameter.

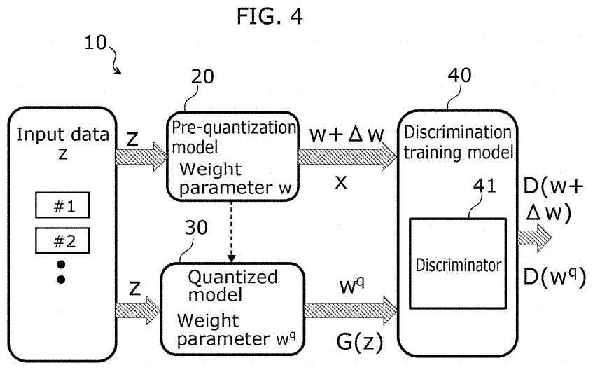

FIG. 4 is a diagram illustrating derivation model 10 for deriving a neural network in Embodiment 1. As shown by FIG. 4, derivation model 10 includes pre-quantization model 20, quantized model 30, and discrimination training model 40.

For example, pre-quantization model 20 is a model in which machine learning is executed under certain conditions, and quantized model 30 finally becomes an inference model that is obtained by quantizing pre-quantization model 20 and is to be mounted on an LSI etc. Discrimination training model 40 is a model for training discriminator 41 that determines the accuracy of an inferred value. Each of pre-quantization model 20, quantized model 30, and discriminator 41 includes a neural network. Moreover, each of pre-quantization model 20, quantized model 30, and discrimination training model 40 has a training state and an inference state, and a weight parameter of the model is constant in the inference state.

These models each have a multi-layer structure and include an input layer, an intermediate layer, and an output layer, etc. Each of the layers includes nodes (not shown) corresponding to neurons. The strength of a connection between neurons is represented by a weight parameter. Although a neural network has weight parameters, in order to facilitate understanding, a weight parameter will be described below as an example of weight parameters.

Pre-quantization model 20 includes a first neural network having weight parameter (first parameter) w. Weight parameter w is expressed by, for example, a first numeric representation such as a real number consisting of a float (floating-point accuracy) value. Input data z is inputted to pre-quantization model 20. Input data z is training data and has various input patterns. Pre-quantization model 20, to which input data z is inputted, outputs inferred value x as an output value. Machine learning is executed in pre-quantization model 20 based on a predetermined training data set including input data z. When discriminator 41 is trained, pre-quantization model 20 operates with weight parameter w+Δw obtained by adding Δw to weight parameter w.

Quantized model 30 includes a second neural network having weight parameter (second parameter) w^{q}. Weight parameter w^{q} is obtained by converting weight parameter w of pre-quantization model 20 into a second numeric representation different from the above-described first numeric representation. The second numeric representation is a numeric representation based on fixed-point accuracy, such as an integer. Specifically, weight parameter w^{q} is obtained by quantizing weight parameter w+Δw obtained by adding Δw to weight parameter w. As a result, weight parameter w^{q} is a value obtained by adding a quantization error to a value obtained by adding a variation to weight parameter w. Input data z is inputted to quantized model 30. Quantized model 30, to which input data z is inputted, outputs inferred value G(x) as an output value.

Discrimination training model 40 is a model for training discriminator 41 that determines the accuracy of an inferred value, and includes discriminator 41 etc.

Pre-quantization weight parameter w+Δw and quantized weight parameter w^{q} are inputted to discriminator 41. Discriminator 41 outputs inferred value D(w+Δw) in response to weight parameter w+Δw, and outputs inferred value D(w^{q}) in response to weight parameter w^{q}.

Inferred value (first inferred value) x of pre-quantization model 20 and inferred value (second inferred value) G(z) of quantized model 30 are inputted to discrimination training model 40. Discrimination training model 40 contrasts inputted inferred value x and inferred value G(z) with above-described inferred values D(w+Δw) and D(w^{q}), and trains discriminator 41 by performing backpropagation. Then, discrimination training model 40 derives a regularization term using trained discriminator 41. The regularization term derived by discrimination training model 40 is used when the first neural network of pre-quantization model 20 is trained again. Discrimination training model 40 will be described in detail later.

### [1-2. Neural Network Derivation Method]

The following describes a method of deriving a neural network using above-described derivation model 10.

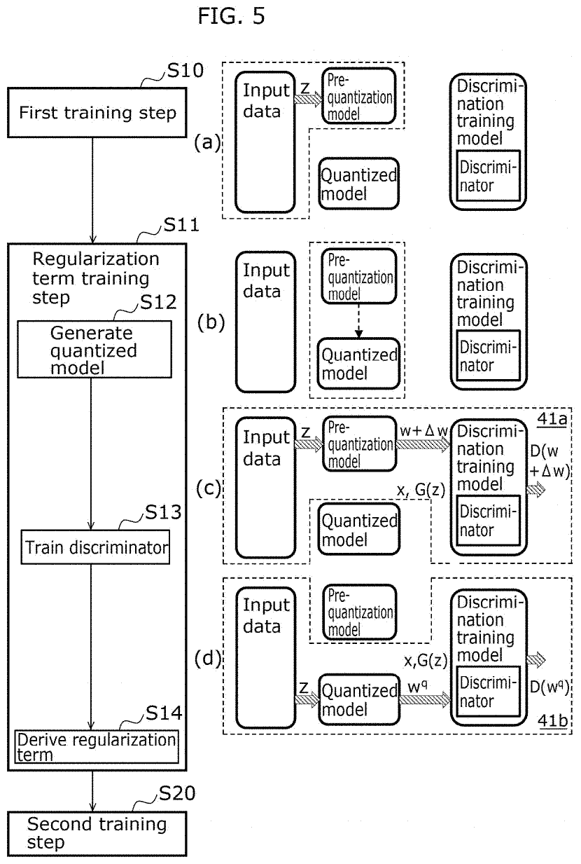

FIG. 5 is a flowchart illustrating a neural network derivation method according to the present embodiment.

The neural network derivation method includes first training step S10, regularization term training step (first regularization term training step) S11, and second training step S20.

First training step S10 is a step of training a first neural network of pre-quantization model 20. First training step S10 is executed within the broken line indicated by (a) in FIG. 5. In this step, the first neural network is trained using a predetermined training data set, with a first loss function for optimization. First training step S10 calculates weight parameter w in the first neural network.

Regularization term training step S11 is a step of performing training to derive a regularization term. Regularization term training step S11 includes step S12 of generating quantized model 30, step S13 of training discriminator 41, and step S14 of deriving a regularization term from discriminator 41.

Step S12 of generating quantized model 30 is a step of training a second neural network having weight parameter w^{q} based on the first neural network. Step S12 is executed within the broken line indicated by (b) in FIG. 5. Weight parameter w^{q} is obtained by quantizing a value obtained by adding a further variation to weight parameter w+Δw, and is calculated by, for example, quantizing weight parameter w+Δw.

Step S13 of training discriminator 41 is executed in a branch within the broken line indicated by each of (c) and (d) in FIG. 5. Here, the branch within the broken line indicated by (c) in FIG. 5 is referred to as branch for pre-quantization model 41a, and the branch within the broken line indicated by (d) in FIG. 5 is referred to as branch for quantized model 41b.

As shown by (c) in FIG. 5, weight parameter w+Δw is inputted to discriminator 41 in branch for pre-quantization model 41a. Δw increases the number of samples at the time of training, and is generated as a random number, for example, with the half of a quantization step as the maximum value. Discriminator 41, to which weight parameter w+Δw is inputted, outputs inferred value D(w+Δw). Moreover, inferred values x and G(z) that are outputs of pre-quantization model 20 and quantized model 30 are inputted to discrimination training model 40. Discrimination training model 40 trains discriminator 41 so that the accuracy of inferred value D(w+Δw) increases, based on a time-series variation in similarity between inferred value x and inferred value G(z).

The term “similarity” indicates a degree of similarity between inferred values x and G(z). A high similarity means a high accuracy of an inferred value. For example, a cosine similarity shown by (Equation 1) is used as a similarity. It should be noted that in (Equation 1), values obtained by vectorizing inferred values x and G(z) (changing the dimensionality of a tensor shape to one dimension) are denoted by Vₓ and V_{Gz}.

$$\begin{matrix} [ Math . 1 ] & \\ similarity ( x , G ( z ) ) = \frac{{V}_{x} \cdot {V}_{Gz}}{‖ {V}_{x} ‖ ‖ {V}_{Gz} ‖} = \frac{{Σ}_{i = 1}^{n} {V}_{{x}_{i}} {V}_{{Gz}_{i}}}{\sqrt{{Σ}_{i = 1}^{n} {V}_{{x}_{i}^{2}}} \sqrt{{Σ}_{i = 1}^{n} {V}_{{Gz}_{i}^{2}}}} & ( Equation 1 )\end{matrix}$$

As stated above, in branch for pre-quantization model 41a, discriminator 41 is trained while pre-quantization model 20 is kept constant.

As shown by (d) in FIG. 5, weight parameter w^{q} (w^{q}=quantizer (w+Δw)) of quantized model 30 is inputted to discriminator 41 in branch for quantized model 41b. Discriminator 41, to which weight parameter w^{q}, is inputted outputs inferred value D(w^{q}). Discrimination training model 40 trains discriminator 41 so that the accuracy of inferred value D(w^{q}) increases, based on a time-series variation in similarity between inferred value x and inferred value G(z) that are inputted. As stated above, in branch for pre-quantization model 41b, discriminator 41 is trained while quantized model 30 is kept constant.

It should be noted that weights in branch for pre-quantization model 41a and branch for quantized model 41b are standardized (a weight parameter in branch for pre-quantization model 41 is quantized to be a weight parameter in branch for quantized model 41b), the training of discriminator 41 is simultaneously performed in branches 41a and 41b.

Step S14 of deriving a regularization term is a step of deriving a regularization term using discriminator 41. A regularization term has a negative correlation with the magnitude of a similarity between inferred value x and inferred value G(z). For example, in a time series, a regularization term is determined to be smaller when the similarity is higher, and is determined to be larger when the similarity is lower. The regularization term derived from discriminator 41 is reflected in the training of the first neural network of pre-quantization model 20.

Second training step S20 is a step of training the first neural network using a second loss function (second loss function=first loss function+regularization term) for optimization obtained by adding a regularization term to the first loss function. Second training step S20 is also executed within the broken line indicated by (a) in FIG. 5, and a predetermined training data set is used in second training step S20 in the same manner as first training step S10. The training in second training step S20 is performed while discrimination training model 40 is kept constant. Second training step S20 updates weight parameter w of the first neural network.

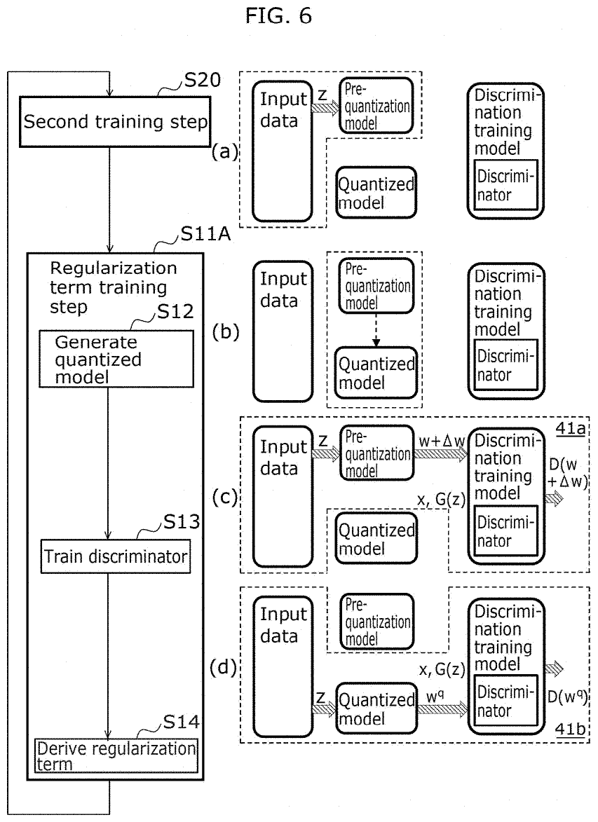

FIG. 6 is a flowchart illustrating a neural network derivation method executed following FIG. 5. In this neural network derivation method, regularization term training step S11A identical to regularization term training step S11 is performed after second training step S20. Regularization term training step S11A includes step S12 of generating quantized model 30, step S13 of training discriminator 41, and step S14 of deriving a regularization term from discriminator 41.

In the neural network derivation method in the present embodiment, the first neural network having robustness is generated by repeating second training step S20 and regularization term training step S11A. In addition, the second neural network having weight parameter w^{q} and robustness is generated by quantizing weight parameter w of the first neural network generated by the above repetition.

These trainings are completed when a training level of discriminator 41 reaches at least a predetermined level. In addition, the trainings may be completed when a similarity between inferred value x and inferred value G(z) reaches at least a predetermined threshold value.

It should be noted that although the iteration example (S20→S11A→S20→S11A . . . →S20) in which second training step S20 and regularization term training step S11A are alternately repeated has been described above, an iteration example is not limited to this. For example, second training step S20 and regularization term training step S11A may be repeated in the order of (S20→S11A→S11A)→(S20→S11A→S11A)→ . . . →S20.

### [1-3. Operation of Discrimination Training Model]

The following describes the operation of discrimination training model 40 for training discriminator 41.

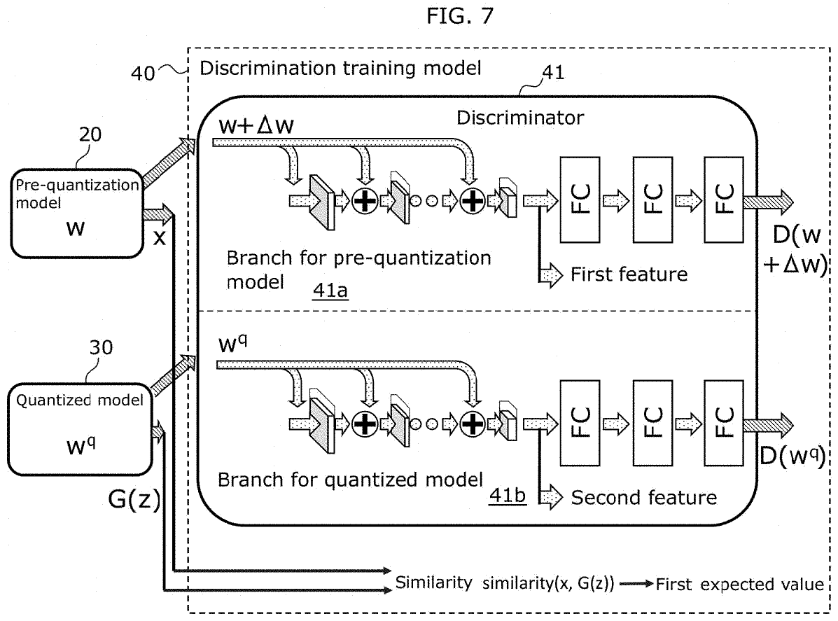

FIG. 7 is a schematic diagram illustrating discrimination training model 40 included in derivation model 10. It should be noted that FIG. 7 also shows pre-quantization model 20 and quantized model 30.

Discriminator 41 includes a convolution neural network (CNN) and a fully-connected neural network (FC). Weight parameter w+Δw and weight parameter w^{q} are inputted to discriminator 41, and corresponding inferred value D(w+Δw) and inferred value D(w^{q}) are outputted from discriminator 41.

Moreover, inferred value x and inferred value G(z) are inputted to discrimination training model 40 from pre-quantization model 20 and quantized model 30, respectively. Discrimination training model 40 trains discriminator 41 using a similarity and an expected value calculated from inferred value x and inferred value G(z).

The following describes an expected value (a first expected value) used when discriminator 41 is trained. An expected value is a label when training is performed, and is determined based on inferred values x and G(z) inputted to discrimination training model 40, as shown by (Equation 2).

Expected value={similarity of inferred value (x or G(z)) to x, increase in similarity of inferred value (x or G(z)) to x from previously evaluated similarity of inferred value (x or G(z)) to x} (Equation 2)

Table 1 shows expected values for each of branch for pre-quantization model 41a and branch for quantized model 41b of discriminator 41. When the quality of inferred values D(w+Δw) and D(w^{q}), the outputs of discriminator 41, is determined, discriminator 41 is trained as a two-class classifier that is a discriminator that can be relatively easily trained. For this reason, the above-described expected values are represented by binary numbers of 0 and 1.

TABLE 1

| | High similarity | Low similarity |
|---|---|---|
| Branch for pre- | Expected value | Expected value |
| quantization model | {1, 1} | {1, 0} |
| Branch for | Expected value | Expected value |
| quantized model | {0, 1} | {0, 0} |

As shown by Table 1, since inferred value x is identical to x, the similarity to x in branch for pre-quantization model 41a is an expected value of 1. Since inferred value G(z) is different from x, the similarity to x in branch for quantized model 41b is an expected value of 0. When a currently calculated similarity of each of inferred values x and G(z) of respective branch for pre-quantization model 41a and branch for quantized model 41b increases from a previously calculated similarity of the same, an expected value for the increase is 1; and when the currently calculated similarity does not increase from the previously calculated similarity, an expected value for the increase is 0. It should be noted that since inferred value x is always compared to x in branch for pre-quantization model 41a, an expected value for an increase in similarity in training is substantially 1.

Discrimination training model 40 trains discriminator 41 using an expected value determined in the above manner. Specifically, discrimination training model 40 trains discriminator 41 so that inferred values D(w+Δw) and D(w^{q}) to be outputted from discriminator 41 become closer to the expected value of 1. Discriminator 41 is trained using both branch for pre-quantization model 41a and branch for quantized model 41b, and weights in a neural network of discriminator 41 are updated. After discriminator 41 is trained, a regularization term is derived using discriminator 41. It should be noted that a regularization term derived in branch for pre-quantization model 41a of discriminator 41 is reflected in the first neural network of pre-quantization model 20.

Although an expected value (the first expected value) is represented by the binary numbers of 0 and 1 in the above, the present disclosure is not limited to this. An expected value may be represented by two values of 0 and S, S being greater than 0. For example, for inferred value x, an expected value may be always S, S being greater than 0, and for inferred value G(z), an expected value may be −S when a similarity is high compared to preceding expected value G(z) in a time-series view of expected value G(z); and an expected value may be 0 when the similarity is not high compared to preceding expected value G(z) in the time-series view of expected value G(z).

It should be noted that discriminator 41 may be trained using a third loss function for optimization having, as inputs, (i) a first feature calculated based on weight parameter w+Δw and (ii) a second feature calculated based on weight parameter w^{q}.

The first feature and the second feature are each a value outputted from the convolution neural network, at a boundary between the convolution neural network and the fully-connected neural network of discriminator 41. The first feature is a feature in branch for pre-quantization model 41a, and the second feature is a feature in branch for quantized model 41b.

The third loss function of discriminator 41 is set in training of discriminator 41, based on these first and second features, and discriminator 41 is trained using the third loss function as the index so that the third loss function becomes smaller.

Examples of the third loss function include a triplet loss function. The triplet loss function has a feature (a reference value, value a and value b derived from the reference value) of a neural network as a factor, and is characterized by decreasing distance between the reference value and value a and increasing distance between the reference value and value b, by training. Accordingly, it is possible to put (i) the reference value or value a and (ii) value b into a readily separable state, and facilitate training.

For example, regarding training repeat count N, in order to put a feature (a positive feature) in branch for pre-quantization model 41a and a feature (a negative feature) in branch for quantized model 41b into a readily separable state, it is desirable to set the following:

Reference value: (N−1)th feature in branch for pre-quantization model 41a

Value a: Nth feature in branch for pre-quantization model 41a

Value b: Nth feature in branch for quantized model 41b

These values can be expressed by the following Equation 3.

$$\begin{matrix} [ Math . 2 ] & \\ {d}_{p}^{[ N ]} = distance ( {{IF}_{D} ( w )}_{[ N - 1 ]} , {{IF}_{D} ( w )}_{[ N ]} ) & ( Equation 3 ) \\ {d}_{n}^{[ N ]} = distance ( {{IF}_{D} ( w )}_{[ N ]} , {{IF}_{D} ( {w}^{q} )}_{[ N ]} ) & \\ {L}_{improved\_triple t}^{[ N ]} = max ( {d}_{p}^{[ N ]} - {d}_{n}^{[ N ]} + α , 0 ) + max ( {d}_{p}^{[ N ]} - β , 0 ) & \end{matrix}$$

To put it another way, when the third loss function is set, it is desirable that a first feature obtained in (N−1)th training be set as a reference feature, N being greater than 1, a first feature obtained in Nth training be set as a positive feature, and a second feature obtained in the Nth training be set as a negative feature.

### [1-4. Hardware Configuration]

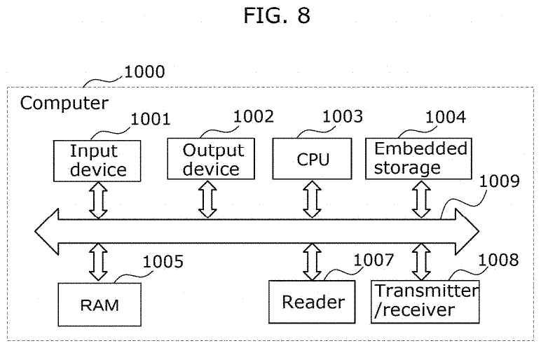

The following describes a hardware configuration of a derivation device included in the neural network derivation model according to the present embodiment, with reference to FIG. 8. FIG. 8 is a diagram illustrating an example of the hardware configuration of computer 1000 that implements, using software, the functions of the derivation device.

As shown by FIG. 8, computer 1000 includes input device 1001, output device 1002, central processing unit (CPU) 1003, embedded storage 1004, random access memory (RAM) 1005, reader 1007, transmitter/receiver 1008, and bus 1009. Input device 1001, output device 1002, CPU 1003, embedded storage 1004, RAM 1005, reader 1007, and transmitter/receiver 1008 are connected by bus 1009.

Input device 1001 serves as a user interface including an input button, a touch pad, a touch panel display, etc., and receives a user operation. It should be noted that input device 1001 may be configured to not only receive a user touch operation, but also receive a voice operation and a remote operation using a remote controller.

Output device 1002 is used in combination with input device 1001, includes a touch pad or a touch panel display etc., and notifies necessary information to a user.

Embedded storage 1004 is a flash memory etc. Moreover, embedded storage 1004 may store in advance at least one of a program for implementing the functions of the derivation device or an application that uses the functional configuration of the derivation device.

RAM 1005 is a random access memory and is used to store data etc. when a program or an application is executed.

Reader 1007 reads information from a recording medium such as a universal serial bus (USB) memory. Reader 1007 reads the above-described program or application from a recording medium on which the program or application is recorded on, and causes embedded storage 1004 to store the program or application.

Transmitter/receiver 1008 is a communication circuit for performing wired or wireless communication. For example, transmitter/receiver 1008 communicates with a server device connected to a network, downloads the above-described program or application from the server device, and causes embedded storage 1004 to store the program or application.

CPU 1003 is a central processing unit, copies a program or an application stored in embedded storage 1004 onto RAM 1005, sequentially reads, from RAM 1005, commands included in the program or the application and executes the commands.

### [1-5. Advantageous Effects Etc.]

As stated above, the neural network derivation method according to the present embodiment includes: first training step S10 of training a first neural network having a first parameter (e.g., weight parameter w), using a first loss function for optimization; and second training step S20 of training the first neural network using a second loss function for optimization, after first training step S10, the second loss function being obtained by adding a regularization term to the first loss function. After the second neural network having the second parameter (e.g., weight parameter w^{q}) obtained by adding a variation to the first parameter based on the first neural network is derived, the regularization term is determined based on a time-series variation in similarity between first inferred value x of the first neural network and second inferred value G(z) of the second neural network.

Accordingly, it is possible to calculate the regularization term based on the time-series variation in similarity between first inferred value x of the first neural network and second inferred value G(z) of the second neural network, and train the first neural network using, as the index, the second loss function including the regularization term. As a result, it is possible to derive a neural network having robustness to a variation in parameter of the neural network.

Moreover, the regularization term may be determined to be smaller when the similarity is higher, and may be determined to be larger when the similarity is lower.

Accordingly, it is possible to prevent the first parameter used in a neural network from becoming a parameter likely to change the accuracy of an inferred value. As a result, it is possible to derive a neural network having robustness to a variation in parameter of the neural network.

Moreover, the neural network derivation method further includes first regularization term training step S11 of training discriminator 41 for determining a regularization term, between first training step S10 and second training step S20. In first regularization term training step S11: the first parameter and the second parameter may be inputted to discriminator 41; and discriminator 41 may be trained using a first expected value calculated from first inferred value x and second inferred value G(z).

Accordingly, since discriminator 41 can be trained using the first expected value, it is possible to train the first neural network using, as the index, the second loss function including the regularization term determined by trained discriminator 41. As a result, it is possible to derive a neural network having robustness to a variation in parameter of the neural network.

Moreover, for first inferred value x, the first expected value may be always S, S being greater than 0, and for second inferred value G(z), the first expected value may be −S when the similarity is high compared to preceding second inferred value G(z) in a time-series view of second inferred value G(z); and the first expected value may be 0 when the similarity is not high compared to preceding second inferred value G(z) in the time-series view of second inferred value G(z).

Accordingly, it is possible to determine the first expected value appropriately and train discriminator 41 appropriately. For this reason, it is possible to train the first neural network using, as the index, the second loss function including the regularization term determined by trained discriminator 41. As a result, it is possible to derive a neural network having robustness to a variation in parameter of the neural network.

Moreover, in first regularization term training step S11, discriminator 41 may be trained using a third loss function having, as inputs, a first feature calculated based on the first parameter and a second feature calculated based on the second parameter.

Accordingly, since it is possible to train discriminator 41 appropriately, it is possible to train the first neural network using, as the index, the second loss function including the regularization term determined by trained discriminator 41. As a result, it is possible to derive a neural network having robustness to a variation in parameter of the neural network.

Moreover, the third loss function may be a triplet loss function, the first feature obtained in (N−1)th training may be set as a reference feature, N being greater than 1, the first feature obtained in Nth training may be set as a positive feature, and the second feature obtained in the Nth training may be set as a negative feature.

Accordingly, it is possible to train discriminator 41 appropriately, based on the third loss function. For this reason, it is possible to train the first neural network using, as the index, the second loss function including the regularization term determined by trained discriminator 41. As a result, it is possible to derive a neural network having robustness to a variation in parameter of the neural network.

Moreover, the first parameter may be expressed by a first numeric representation, and the second parameter may be obtained by converting the first parameter into a second numeric representation.

Even when a parameter is converted from the first numeric representation to the second numeric representation, the neural network derivation method according to the present embodiment makes it possible to derive a neural network having robustness to the conversion.

Moreover, the first numeric representation may be a real number consisting of a float value, and the second numeric representation may be an integer, and the second parameter may be obtained by quantizing the first parameter.

Even when a parameter is quantized and converted, the neural network derivation method according to the present embodiment makes it possible to derive a neural network having robustness to the conversion.

### Embodiment 2

### [2-1. Derivation Model for Deriving Neural Network]

A derivation model for deriving a neural network will be described in Embodiment 2. Specifically, in Embodiment 2, the following describes an example of generating a neural network having robustness to a variation in input data in addition to the robustness to the variation in parameter described in Embodiment 1.

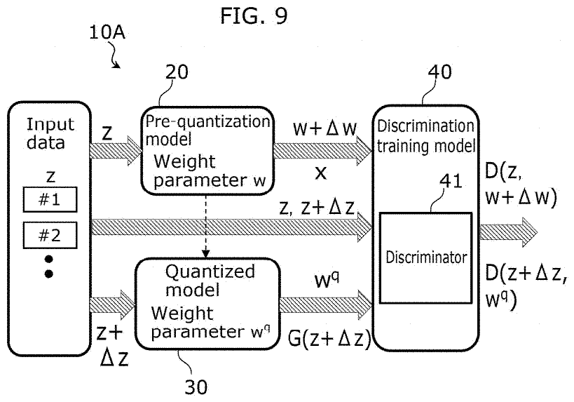

FIG. 9 is a diagram illustrating derivation model 10A for deriving a neural network in Embodiment 2. As shown by FIG. 9, derivation model 10A includes pre-quantization model 20, quantized model 30, and discrimination training model 40.

Pre-quantization model 20 includes a first neural network having weight parameter (first parameter) w. Input data (first input data) z is inputted to pre-quantization model 20. Input data z is expressed by, for example, a third numeric representation such as a real number consisting of a float value. Pre-quantization model 20, to which input data z is inputted, outputs inferred value (third inferred value) x as an output value. Machine learning is executed on pre-quantization model 20 based on a predetermined training data set including input data z. When discriminator 41 is trained, pre-quantization model 20 operates with weight parameter w+Δw obtained by adding Δw to weight parameter w.

Quantized model 30 includes a second neural network having weight parameter (second parameter) w^{q}. Input data (second input data) z+Δz is inputted to quantized model 30. Δz is calculated by, for example, keeping a weight parameter of trained pre-quantization model 20 constant and training input data z so that input data z becomes an incorrect inferred value. In this case, Δz is obtained as a difference from original input data z. Input data z+Δz is expressed by a fourth numeric representation different from the above-described third numeric representation. The fourth numeric representation is a numeric representation based on fixed-point accuracy, such as an integer. Input data z+Δz is a value obtained by adding a variation to input data z, and is slightly different in value from input data z. Quantized model 30, to which input data z+Δz is inputted, outputs inferred value (fourth inferred value) G(z+Δz) as an output value.

Discrimination training model 40 is a model for training discriminator 41 that determines the accuracy of an inferred value, and includes discriminator 41 etc.

Pre-quantization weight parameter w+Δw, quantized weight parameter w^{q}, and input data z and z+Δz are inputted to discriminator 41. Discriminator 41 outputs inferred value D(z, w+Δw) in response to input data z and weight parameter z+Δz. In addition, discriminator 41 outputs inferred value D(z+Δz, w^{q}) in response to input data z+Δz and weight parameter w^{q}. It should be noted that the expression “inferred value D(A, B)” means an inferred value dependent on both tensor A and tensor B.

Inferred value x of pre-quantization model 20 and inferred value G(z+Δz) of quantized model 30 are inputted to discrimination training model 40. Discrimination training model 40 contrasts inputted inferred value x and inferred value G(z+Δz) with above-described inferred values D(z, w+Δw) and D(z+Δz, w^{q}), and trains discriminator 41 by performing backpropagation. Then, discrimination training model 40 derives a regularization term using trained discriminator 41. The regularization term derived by discrimination training model 40 is used when the first neural network of pre-quantization model 20 is trained again.

### [2-2. Neural Network Derivation Method]

The following describes a method of deriving a neural network using above-described derivation model 10A.

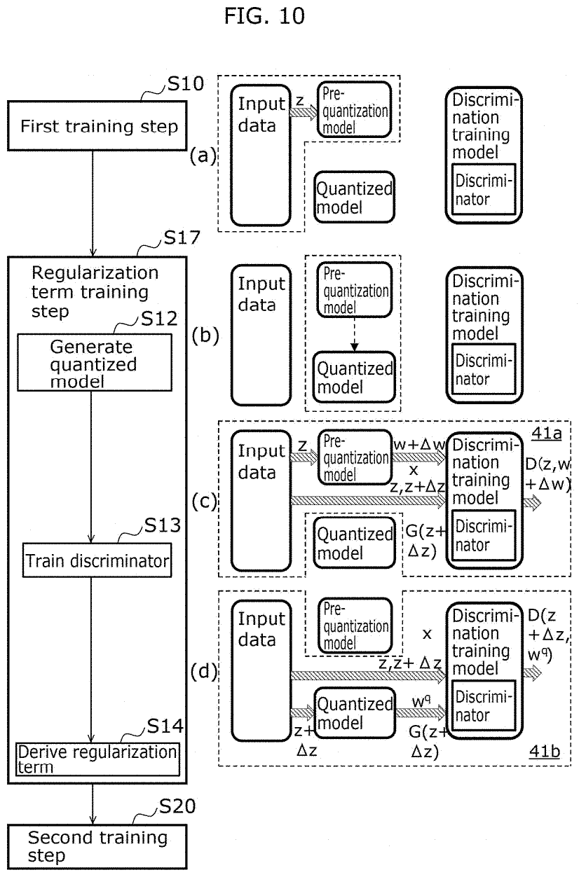

FIG. 10 is a flowchart illustrating a neural network derivation method according to the present embodiment.

The neural network derivation method includes first training step S10, regularization term training step S17 (second regularization term training step), and second training step S20.

First training step S10 is a step of training a first neural network of pre-quantization model 20. First training step S10 is executed within the broken line indicated by (a) in FIG. 10. In this step, the first neural network is trained using a predetermined training data set, with a first loss function for optimization. First training step S10 calculates weight parameter w in the first neural network.

Regularization term training step S17 is a step of performing training to derive a regularization term. Regularization term training step S17 includes step S12 of generating quantized model 30, step S13 of training discriminator 41, and step S14 of deriving a regularization term from discriminator 41.

Step S12 of generating quantized model 30 is a step of training a second neural network having weight parameter w^{q}, based on the first neural network. Step S12 is executed within the broken line indicated by (b) in FIG. 10. Weight parameter w^{q} is obtained by quantizing a value obtained by adding a further variation to weight parameter w+Δw, and is calculated by, for example, quantizing weight parameter w+Δw.

Step S13 of training discriminator 41 is executed in a branch within the broken line indicated by each of (c) and (d) in FIG. 10. Here, the branch within the broken line indicated by (c) in FIG. 10 is referred to as branch for pre-quantization model 41a, and the branch within the broken line indicated by (d) in FIG. 5 is referred to as branch for quantized model 41b.

As shown by (c) in FIG. 10, weight parameter w+Δw and input data z are inputted to discriminator 41 in branch for pre-quantization model 41a. Discriminator 41, to which weight parameter w+Δw and input data z are inputted, outputs inferred value D(z, w+Δw). Moreover, inferred values x and G(z+Δz) that are outputs of pre-quantization model 20 and quantized model 30 are inputted to discrimination training model 40. Discrimination training model 40 trains discriminator 41 so that the accuracy of inferred value D(z, w+Δw) increases, based on a time-series variation in similarity between inferred value x and inferred value G(z+Δz).

The term “similarity” indicates a degree of similarity between inferred values x and G(z+Δz). The above-described cosine similarity is used as a similarity.

As shown by (d) in FIG. 10, weight parameter w^{q} and input data z+Δz of quantized model 30 are inputted to discriminator 41 in branch for quantized model 41b. Discriminator 41, to which weight parameter w^{q} and input data z+Δz are inputted, outputs inferred value D(z+Δz, w^{q}). Discrimination training model 40 trains discriminator 41 so that the accuracy of inferred value D(z+Δz, w^{q}) increases, based on a time-series variation in similarity between inferred value x and inferred value G(z+Δz) that are inputted.

It should be noted that weights in branch for pre-quantization model 41a and branch for quantized model 41b are standardized (a weight parameter in branch for pre-quantization model 41a is quantized to be a weight parameter in branch for quantized model 41b), the training of discriminator 41 is simultaneously performed in branches 41a and 41b.

Step S14 of deriving a regularization term is a step of deriving a regularization term using discriminator 41. A regularization term has a negative correlation with the magnitude of a similarity between inferred value x and inferred value G(z+Δz). For example, in a time series, a regularization term is determined to be smaller when the similarity is higher, and is determined to be larger when the similarity is lower. The regularization term derived from discriminator 41 is reflected in the training of the first neural network of pre-quantization model 20.

Second training step S20 is a step of training the first neural network using a second loss function (second loss function=first loss function+regularization term) for optimization obtained by adding a regularization term to the first loss function. Second training step S20 is also executed within the broken line indicated by (a) in FIG. 10, and a predetermined training data set is used in second training step S20 in the same manner as first training step S10. Second training step S20 updates weight parameter w of the first neural network.

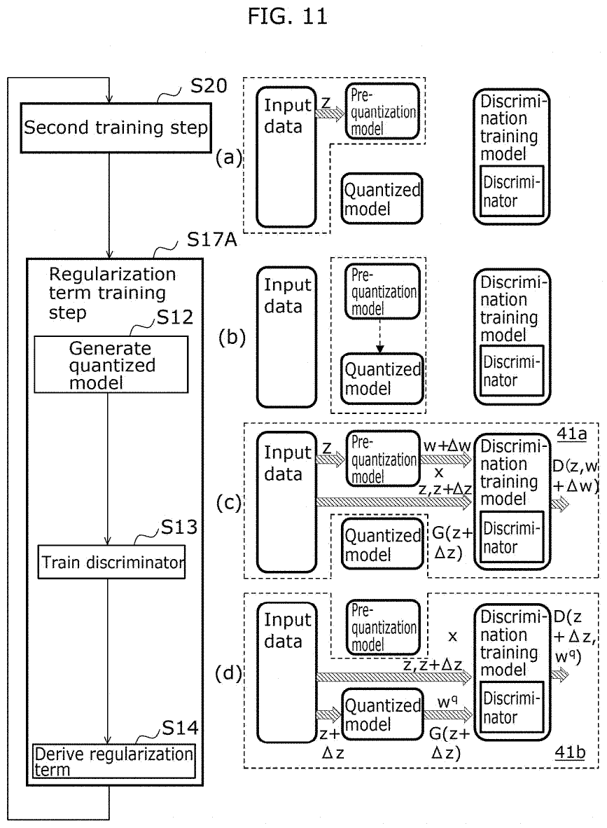

FIG. 11 is a flowchart illustrating a neural network derivation method executed following FIG. 10. In this neural network derivation method, regularization term training step S17A identical to regularization term training step S17 is performed after second training step S20. Regularization term training step S17A includes step S12 of generating quantized model 30, step S13 of training discriminator 41, and step S14 of deriving a regularization term from discriminator 41.

In the neural network derivation method in the present embodiment, the first neural network having robustness is generated by repeating second training step S20 and regularization term training step S17A. In addition, the second neural network having robustness to a variation in parameter and input data is generated by quantizing weight parameter w of the first neural network generated by the above repetition.

### [2-3. Operation of Discrimination Training Model]

The following describes the operation of discrimination training model 40 for training discriminator 41.

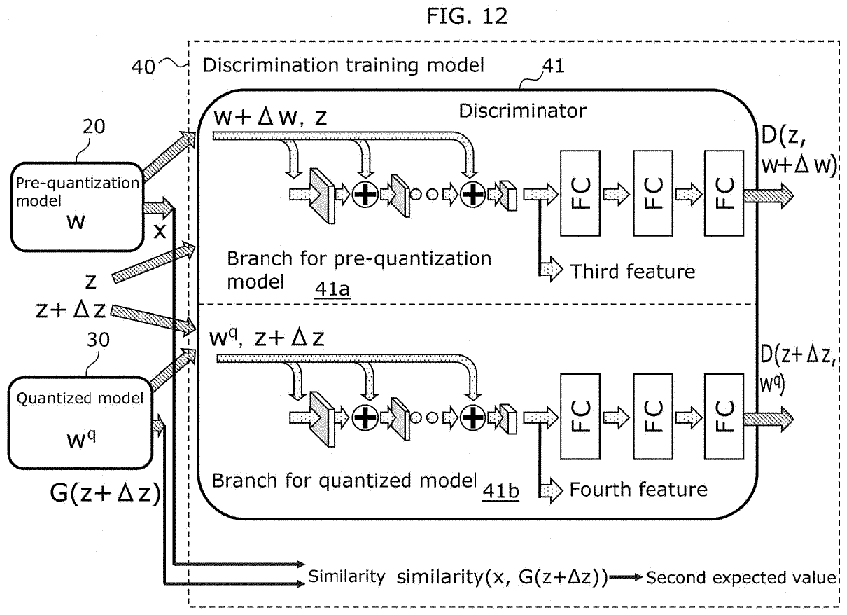

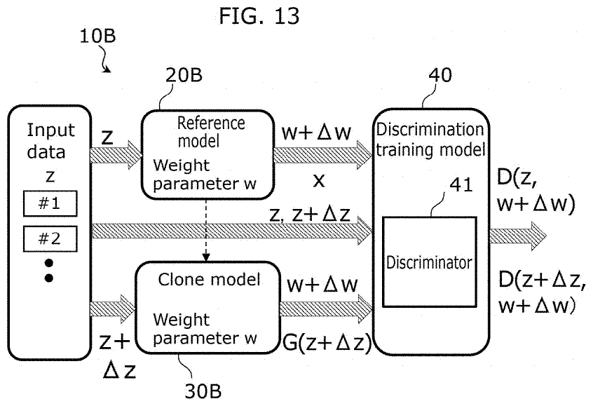

FIG. 12 is a schematic diagram illustrating discrimination training model 40 included in derivation model 10A. It should be noted that FIG. 12 also shows pre-quantization model 20 and quantized model 30.

Weight parameter w+Δw and input data z are inputted to branch for pre-quantization model 41a of discriminator 41, and inferred value D(z, w+Δw) is outputted from branch for pre-quantization model 41a. Weight parameter w^{q} and input data z+Δz are inputted to branch for quantized model 41b of discriminator 41, and inferred value D(z+Δz, w^{q}) is outputted from branch for quantized model 41b.

Moreover, inferred value x and inferred value G(z+Δz) are inputted to discrimination training model 40 from pre-quantization model 20 and quantized model 30, respectively. Discrimination training model 40 trains discriminator 41 using a similarity and an expected value calculated from inferred value x and inferred value G(z+Δz).

The following describes an expected value (a second expected value) used when discriminator 41 is trained.

An expected value is a label when training is performed, and is determined based on inferred values x and G(z+Δz) inputted to discrimination training model 40, as shown by (Equation 4).

Expected value={similarity of inferred value (x or G(z+Δz)) to x, increase in similarity of inferred value (x or G(z+Δz)) to x from previously evaluated similarity of inferred value (x or G(z+Δz)) to x} (Equation 4)

Table 2 shows expected values for each of branch for pre-quantization model 41a and branch for quantized model 41b of discriminator 41. When the quality of inferred values D(z, w+Δw) and D(z+Δz, w^{q}), the outputs of discriminator 41, is determined, discriminator 41 is trained as a two-class classifier that is a discriminator that can be relatively easily trained. For this reason, the above-described expected values are represented by binary numbers of 0 and 1.

TABLE 2

| | High similarity | Low similarity |
|---|---|---|
| Branch for pre- | Expected value | Expected value |
| quantization model | {1, 1} | {1, 0} |
| Branch for | Expected value | Expected value |
| quantized model | {0, 1} | {0, 0} |

As shown by Table 2, since inferred value x is identical to x, the similarity to x for branch for pre-quantization model 41a is an expected value of 1. Since inferred value G(z+Δz) is different from x, the similarity to x for branch for quantized model 41b is an expected value of 0. When a currently calculated similarity of each of inferred values x and G(z+Δz) of respective branch for pre-quantization model 41a and branch for quantized model 41b increases from a previously calculated similarity of the same, an expected value for the increase is 1; and when the currently calculated similarity does not increase from the previously calculated similarity, an expected value for the increase is 0. It should be noted that since inferred value x is always compared to x in branch for pre-quantization model 41a, an expected value for an increase in similarity in training is substantially 1.

Discrimination training model 40 trains discriminator 41 using an expected value determined in the above manner. Specifically, discrimination training model 40 trains discriminator 41 so that inferred values D(z, w+Δw) and D(z+Δz, w^{q}) to be outputted from discriminator 41 become closer to the expected value of 1. Discriminator 41 is trained using both branch for pre-quantization model 41a and branch for quantized model 41b, and weights in a neural network of discriminator 41 are updated. After discriminator 41 is trained, a regularization term is derived using branch for pre-quantization model 41a of discriminator 41.

Although an expected value (the second expected value) is represented by the binary numbers of 0 and 1 in the above, the present disclosure is not limited to this. An expected value may be represented by two values of 0 and S, S being greater than 0. For example, for inferred value x, an expected value may be always S, S being greater than 0, and for inferred value G(z+Δz), an expected value may be −S when a similarity is high compared to preceding inferred value G(z+Δz) in a time-series view of inferred value G(z+Δz); and an expected value may be 0 when the similarity is not high compared to preceding inferred value G(z+Δz) in the time-series view of inferred value G(z+Δz).

It should be noted that discriminator 41 may be trained using a fourth loss function for optimization having, as inputs, (i) a third feature calculated based on weight parameter w+Δw and input data z and (ii) a fourth feature calculated based on weight parameter w^{q} and input data z+Δz.

The third feature and the fourth feature are each a value outputted from the convolution neural network, at a boundary between the convolution neural network and the fully-connected neural network of discriminator 41. The third feature is a feature in branch for pre-quantization model 41a, and the fourth feature is a feature in branch for quantized model 41b.

The fourth loss function of discriminator 41 is set in training of discriminator 41, based on these third and fourth features, and discriminator 41 is trained using the fourth loss function as the index so that the fourth loss function becomes smaller.

Examples of the fourth loss function include a triplet loss function. The triplet loss function has a feature (a reference value, value a and value b derived from the reference value) of a neural network as a factor, and is characterized by decreasing distance between the reference value and value a and increasing distance between the reference value and value b, by training.

For example, regarding training repeat count N, in order to put a feature (a positive feature) in branch for pre-quantization model 41a and a feature (a negative feature) in branch for quantized model 41b into a readily separable state, it is desirable to set the following:

Reference value: (N−1)th feature in branch for pre-quantization model 41a

Value a: Nth feature in branch for pre-quantization model 41a

Value b: Nth feature in branch for quantized model 41b

To put it another way, when the fourth loss function is set, it is desirable that a third feature obtained in (N−1)th training be set as a reference feature, N being greater than 1, a fourth feature obtained in Nth training be set as a positive feature, and a fourth feature obtained in the Nth training be set as a negative feature.

### [2-4. Advantageous Effects Etc.]

As stated above, the neural network derivation method according to Embodiment 2 further includes, in addition to Embodiment 1, second regularization term training step S17 of training discriminator 41 for determining a regularization term, between first training step S10 and second training step S20. In second regularization term training step S17: first input data (e.g., input data z) and second input data (e.g., input data z+Δz) are inputted to discriminator 41; and discriminator 41 is trained using a second expected value calculated from (i) third inferred value x of the first neural network when the first input data is inputted to the first neural network and (ii) fourth inferred value G(z+Δz) of the second neural network when the second input data is inputted to the second neural network, the second input data being obtained by adding a variation to the first input data.

Accordingly, since discriminator 41 can be trained using the second expected value, it is possible to train the first neural network using, as the index, the second loss function including the regularization term determined by trained discriminator 41. As a result, it is possible to derive a neural network having robustness to a variation in parameter and input data. Additionally, this allows a significant increase in resistance to adversarial attacks (attacks by adversarial samples).

Moreover, for third inferred value x, the second expected value may be always S, S being greater than 0, and for fourth inferred value G(z+Δz), the second expected value may be −S when the similarity is high compared to preceding fourth inferred value G(z+Δz) in a time-series view of fourth inferred value G(z+Δz); and the second expected value may be 0 when the similarity is not high compared to preceding fourth inferred value G(z+Δz) in the time-series view of fourth inferred value G(z+Δz).

Accordingly, it is possible to determine the second expected value appropriately and train discriminator 41 appropriately. For this reason, it is possible to train the first neural network using, as the index, the second loss function including the regularization term determined by trained discriminator 41. As a result, it is possible to derive a neural network having robustness to a variation in parameter and input data.

Moreover, in second regularization term training step S17, discriminator 41 may be trained using a fourth loss function having, as inputs, (i) a third feature calculated based on the first parameter and the first input data and (ii) a fourth feature calculated based on the second parameter and the second input data.

Accordingly, since it is possible to train discriminator 41 appropriately, it is possible to train the first neural network using, as the index, the second loss function including the regularization term determined by trained discriminator 41. As a result, it is possible to derive a neural network having robustness to a variation in parameter and input data.

Moreover, the fourth loss function may be a triplet loss function, the third feature obtained in (N−1)th training may be set as a reference feature, N being greater than 1, the third feature obtained in Nth training may be set as a positive feature, and the fourth feature obtained in the Nth training may be set as a negative feature.

Accordingly, it is possible to train discriminator 41 appropriately, based on the fourth loss function. For this reason, it is possible to train the first neural network using, as the index, the second loss function including the regularization term determined by trained discriminator 41. As a result, it is possible to derive a neural network having robustness to a variation in parameter and input data.

Moreover, the first input data may be expressed by a third numeric representation, and the second input data may be expressed by a fourth numeric representation different from the third numeric representation.

Even when input data is converted from the third numeric representation to the fourth numeric representation, the neural network derivation method according to the present embodiment makes it possible to derive a neural network having robustness.

Moreover, the third numeric representation may be a real number consisting of a float value, and the fourth numeric representation may be an integer.

Even when the third numeric representation is a real number consisting of a float value and the fourth numeric representation is an integer, the neural network derivation method according to the present embodiment makes it possible to derive a neural network having robustness.

### Embodiment 3

### [3-1. Derivation Model for Deriving Neural Network]

A derivation model for deriving a neural network will be described in Embodiment 3. Specifically, in Embodiment 3, the following describes an example of generating a neural network having robustness to a variation in input data.

FIG. 13 is a diagram illustrating a derivation model for deriving a neural network in Embodiment 3. As shown by FIG. 13, derivation model 10B includes reference model 20B, clone model 30B, and discrimination training model 40.

Reference model 20B includes a first neural network having weight parameter (first parameter) w. Input data (first input data) z is inputted to reference model 20B. Input data z is expressed by, for example, a third numeric representation such as a real number consisting of a float value. Reference model 20B, to which input data z is inputted, outputs inferred value (fifth inferred value) x as an output value. Machine learning is executed on reference model 20B based on a predetermined training data set including input data z. When discriminator 41 is trained, reference model 20B operates with weight parameter w+Δw obtained by adding Δw to weight parameter w.

Clone model 30B includes a second neural network having the same weight parameter w as that of reference model 20B. Input data (second input data) z+Δz is inputted to clone model 30B. Δz is calculated by, for example, keeping a weight parameter of trained reference model 20B constant and training input data z so that input data z becomes an incorrect inferred value. In this case, Δz is obtained as a difference from original input data z. Input data z+Δz is expressed by a fourth numeric representation different from the above-described third numeric representation. The fourth numeric representation is a numeric representation based on fixed-point accuracy, such as an integer. Input data z+Δz is a value obtained by adding a variation to input data z, and is slightly different in value from input data z. Clone model 30B, to which input data z+Δz is inputted, outputs inferred value (sixth inferred value) G(z+Δz) as an output value. When discriminator 41 is trained, clone model 30B operates with weight parameter w+Δw obtained by adding Δw to weight parameter w.

Discrimination training model 40 is a model for training discriminator 41 that determines the accuracy of an inferred value, and includes discriminator 41 etc.

Two weight parameters w+Δw and input data z and z+Δz are inputted to discriminator 41. Discriminator 41 outputs inferred value D(z, w+Δw) in response to input data z and weight parameter w+Δw. Discriminator 41 also outputs inferred value D(z+Δz, w+Δw) in response to input data z+Δz and weight parameter w+Δw. It should be noted that the expression “inferred value D(A, B)” means an inferred value dependent on both tensor A and tensor B.

Inferred value x of reference model 20B and inferred value G(z+Δz) of clone model 30B are inputted to discrimination training model 40. Discrimination training model 40 contrasts inputted inferred value x and inferred value G(z+Δz) with above-described inferred values D(z, w+Δw) and D(z+Δz, w+Δw), and trains discriminator 41 by performing backpropagation. Then, discrimination training model 40 derives a regularization term using trained discriminator 41. The regularization term derived by discrimination training model 40 is used when the first neural network of reference model 20B is trained again.

### [3-2. Neural Network Derivation Method]

The following describes a method of deriving a neural network using above-described derivation model 10B.

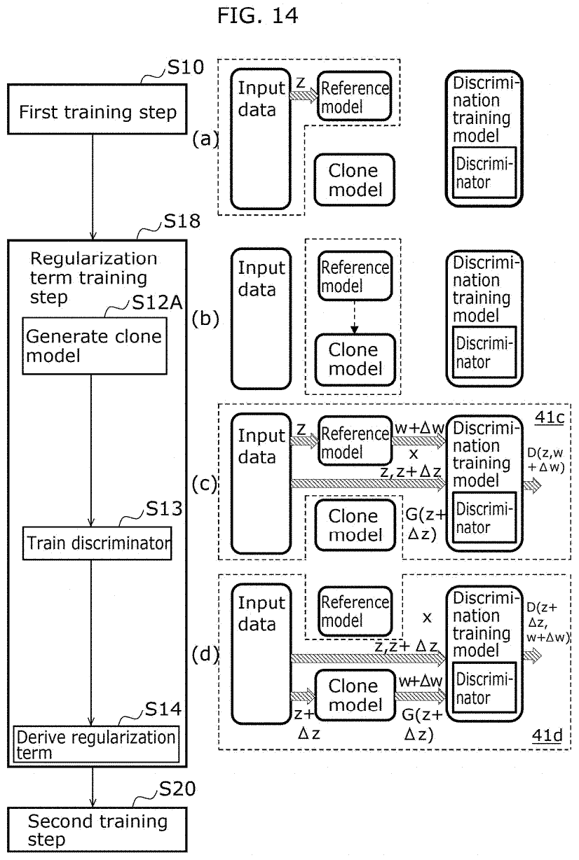

FIG. 14 is a flowchart illustrating a neural network derivation method according to the present embodiment.

The neural network derivation method includes first training step S10, regularization term training step S18 (third regularization term training step), and second training step S20.

First training step S10 is a step of training a first neural network of reference model 20B. First training step S10 is executed within the broken line indicated by (a) in FIG. 14. In this step, the first neural network is trained using a predetermined training data set, with a first loss function for optimization. First training step S10 calculates weight parameter w in the first neural network.

Regularization term training step S18 is a step of performing training to derive a regularization term. Regularization term training step S18 includes step S12A of generating clone model 30B, step S13 of training discriminator 41, and step S14 of deriving a regularization term from discriminator 41.

Step S12A of generating clone model 30B is a step of deriving a second neural network having the same weight parameter w, based on the first neural network. Step S12A is executed within the broken line indicated by (b) in FIG. 14.

Step S13 of training discriminator 41 is executed in a branch within the broken line indicated by each of (c) and (d) in FIG. 14. Here, the branch within the broken line indicated by (c) in FIG. 14 is referred to as branch for reference model 41c, and the branch within the broken line indicated by (d) in FIG. 14 is referred to as branch for clone model 41d.

As shown by (c) in FIG. 14, weight parameter w+Δw and input data z are inputted to discriminator 41 in branch for reference model 41c. Discriminator 41, to which weight parameter w+Δw and input data z are inputted, outputs inferred value D(z, w+Δw). Moreover, inferred values x and G(z+Δz) that are outputs of reference model 20B and clone model 30B are inputted to discrimination training model 40. Discrimination training model 40 trains discriminator 41 so that the accuracy of inferred value D(z, w+Δw) increases, based on a time-series variation in similarity between inferred value x and inferred value G(z+Δz).

The term “similarity” indicates a degree of similarity between inferred values x and G(z+Δz). The above-described cosine similarity is used as a similarity.

As shown by (d) in FIG. 14, weight parameter w+Δw and input data z+Δz of clone model 30B are inputted to discriminator 41 in branch for clone model 41d. Discriminator 41, to which weight parameter w+Δw and input data z+Δz are inputted, outputs inferred value D(z+Δz, w+Δw). Discrimination training model 40 trains discriminator 41 so that the accuracy of inferred value D(z+Δz, w+Δw) increases, based on a time-series variation in similarity between inferred value x and inferred value G(z+Δz) that are inputted.

It should be noted that weights in branch for reference model 41c and branch for clone model 41d are standardized, and the training of discriminator 41 is simultaneously performed in branches 41c and 41d.

Step S14 of deriving a regularization term is a step of deriving a regularization term using discriminator 41. A regularization term has a negative correlation with the magnitude of a similarity between inferred value x and inferred value G(z+Δz). For example, in a time series, a regularization term is determined to be smaller when the similarity is higher, and is determined to be larger when the similarity is lower. The regularization term derived from discriminator 41 is reflected in the training of the first neural network of reference model 20B.

Second training step S20 is a step of training the first neural network using a second loss function (second loss function=first loss function+regularization term) for optimization obtained by adding a regularization term to the first loss function. Second training step S20 is also executed within the broken line indicated by (a) in FIG. 14, and a predetermined training data set is used in second training step S20 in the same manner as first training step S10. Second training step S20 updates weight parameter w in the first neural network.

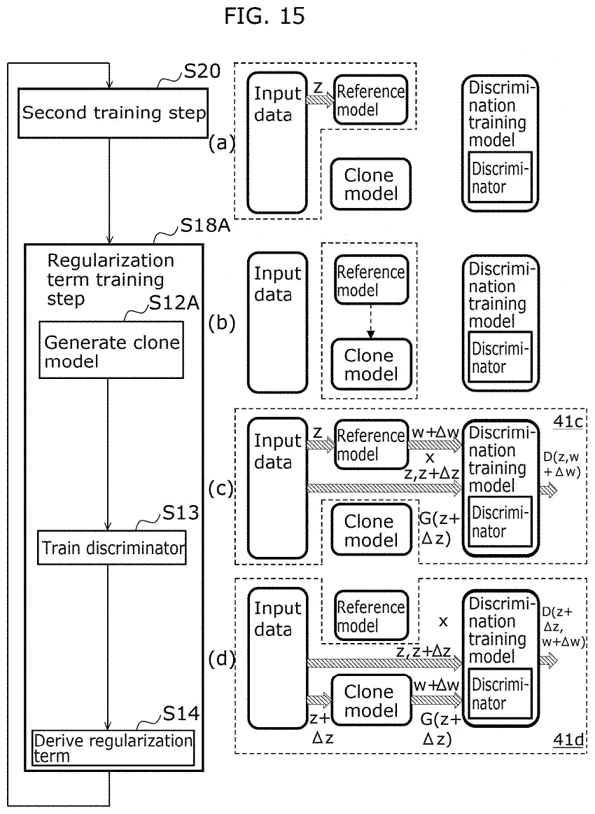

FIG. 15 is a flowchart illustrating a neural network derivation method executed following FIG. 14. In this neural network derivation method, regularization term training step S18A identical to regularization term training step S18 is performed after second training step S20. Regularization term training step S18A includes step S12A of generating clone model 30B, step S13 of training discriminator 41, and step S14 of deriving a regularization term from discriminator 41.

In the neural network derivation method in the present embodiment, the first neural network having robustness is generated by repeating second training step S20 and regularization term training step S18A. In addition, the second neural network having robustness to a variation in input data is generated by giving the second neural network the same weight parameter w as that of the first neural network generated by the above repetition.

### [3-3. Operation of Discrimination Training Model]

The following describes the operation of discrimination training model 40 for training discriminator 41.

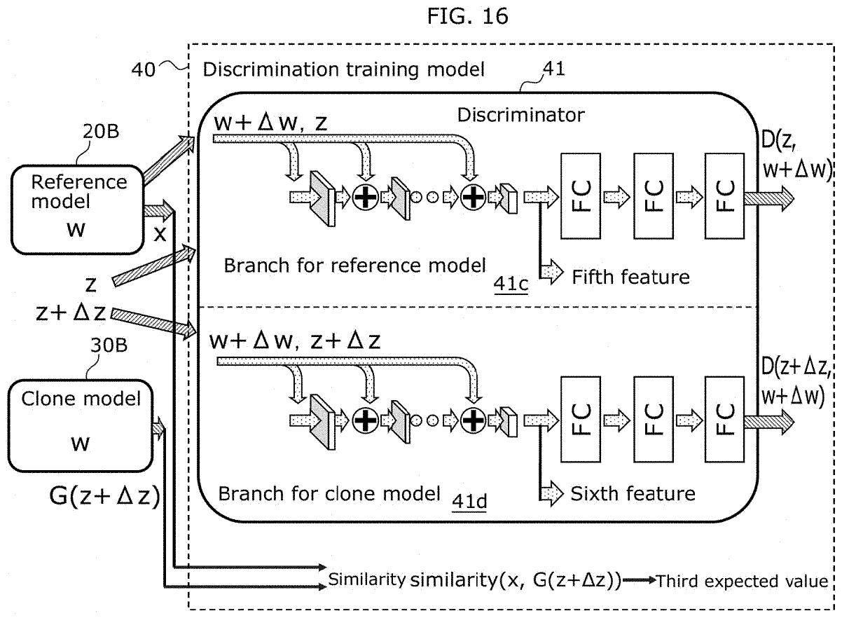

FIG. 16 is a schematic diagram illustrating discrimination training model 40 included in derivation model 10B. It should be noted that FIG. 16 also shows reference model 20B and clone model 30B.

Weight parameter w+Δw and input data z are inputted to branch for reference model 41c of discriminator 41, and inferred value D(z, w+Δw) is outputted from branch for reference model 41c. Weight parameter w+Δw and input data z+Δz are inputted to branch for clone model 41d of discriminator 41, and inferred value D(z+Δz, w+Δw) is outputted from branch for clone model 41d.

Moreover, inferred value x and inferred value G(z+Δz) are inputted to discrimination training model 40 from reference model 20B and clone model 30B, respectively. Discrimination training model 40 trains discriminator 41 using a similarity and an expected value calculated from inferred value x and inferred value G(z+Δz).

The following describes an expected value (a third expected value) used when discriminator 41 is trained.

An expected value is a label when training is performed, and is determined based on inferred values x and G(z+Δz) inputted to discrimination training model 40, as shown by (Equation 5).

Expected value={similarity of inferred value (x or G(z+Δz)) to x, increase in similarity of inferred value (x or G(z+Δz)) to x from previously evaluated similarity of inferred value (x or G(z+Δz)) to x} (Equation 5)

Table 3 shows expected values for branch for reference model 41c and branch for clone model 41d of discriminator 41. When the quality of inferred values D(z, w+Δw) and D(z+Δz, w+Δw), the outputs of discriminator 41, is determined, discriminator 41 is trained as a two-class classifier that is a discriminator that can be relatively easily trained. For this reason, the above-described expected values are represented by binary numbers of 0 and 1.

TABLE 3

| | High similarity | Low similarity |
|---|---|---|
| Branch for | Expected value | Expected value |
| reference model | {1, 1} | {1, 0} |
| Branch for | Expected value | Expected value |
| clone model | {0, 1} | {0, 0} |

As shown by Table 3, since inferred value x is identical to x, the similarity to x for branch for reference model 41c is an expected value of 1. Since inferred value G(z+Δz) is different from x, the similarity to x for branch for clone model 41d is an expected value of 0. When a currently calculated similarity of each of inferred values x and G(z+Δz) of respective branch for reference model 41c and branch for clone model 41d increases from a previously calculated similarity of the same, an expected value of r the increase is 1; and when the currently calculated similarity does not increase from the previously calculated similarity, an expected value for the increase is 0. It should be noted that since inferred value x is always compared to x in branch for reference model 41c, an expected value for an increase in similarity in training is substantially 1.

Discrimination training model 40 trains discriminator 41 using an expected value determined in the above manner. Specifically, discrimination training model 40 trains discriminator 41 so that inferred values D(z, w+Δw) and D(z+Δz, w+Δw) to be outputted from discriminator 41 become closer to the expected value of 1. Discriminator 41 is trained using both branch for reference model 41c and branch for clone model 41d, and weights in a neural network of discriminator 41 are updated. After discriminator 41 is trained, a regularization term is derived using branch for reference model 41c of discriminator 41.

Although an expected value (the third expected value) is represented by the binary numbers of 0 and 1 in the above, the present disclosure is not limited to this. An expected value may be represented by two values of 0 and S, S being greater than 0. For example, for inferred value x, an expected value may be always S, S being greater than 0, and for inferred value G(z+Δz), an expected value may be −S when a similarity is high compared to preceding inferred value G(z+Δz) in a time-series view of inferred value G(z+Δz); and an expected value may be 0 when the similarity is not high compared to preceding inferred value G(z+Δz) in the time-series view of inferred value G(z+Δz).

It should be noted that discriminator 41 may be trained using a fifth loss function for optimization having, as inputs, (i) a fifth feature calculated based on input data z and (ii) a sixth feature calculated based on input data z+Δz.

The fifth feature and the sixth feature are each a value outputted from the convolution neural network, at a boundary between the convolution neural network and the fully-connected neural network of discriminator 41. The fifth feature is a feature in branch for reference model 41c, and the sixth feature is a feature in branch for clone model 41d.

The fifth loss function of discriminator 41 is set in training of discriminator 41, based on these fifth and sixth features, and discriminator 41 is trained using the fifth loss function as the index so that the fifth loss function becomes smaller.

Examples of the fifth loss function include a triplet loss function. The triplet loss function has a feature (a reference value, value a and value b derived from the reference value) of a neural network as a factor, and is characterized by decreasing distance between the reference value and value a and increasing distance between the reference value and value b, by training.

For example, regarding training repeat count N, in order to put a feature (a positive feature) in branch for reference model 41c and a feature (a negative feature) in branch for clone model 41d into a readily separable state, it is desirable to set the following:

Reference value: (N−1)th feature in branch for reference model 41c

Value a: Nth feature in branch for reference model 41c

Value b: Nth feature in branch for clone model 41d

To put it another way, when the fifth loss function is set, it is desirable that a fifth feature obtained in (N−1)th training be set as a reference feature, N being greater than 1, a sixth feature obtained in Nth training be set as a positive feature, and a sixth feature obtained in the Nth training be set as a negative feature.

### [3-4. Advantageous Effects Etc.]

As stated above, the neural network derivation method according to Embodiment 3 includes: first training step S10 of training a first neural network to which first input data (e.g., input data z) is inputted, using a first loss function for optimization; and second training step S20 of training the first neural network using a second loss function for optimization, after first training step S10, the second loss function being obtained by adding a regularization term to the first loss function. After a second neural network to which second input data (e.g., input data z+Δz) obtained by adding a variation to the first input data based on the first neural network is inputted is derived, the regularization term is determined based on a time-series variation in similarity between fifth inferred value x of the first neural network and sixth inferred value G(z+Δz) of the second neural network.

Accordingly, it is possible to calculate the regularization term based on the time-series variation in similarity between fifth inferred value x of the first neural network and sixth inferred value G(z+Δz) of the second neural network, and train the first neural network using, as the index, the second loss function including the regularization term. As a result, it is possible to derive a neural network having robustness to a variation in input data of the neural network. Additionally, this allows a significant increase in resistance to adversarial attacks (attacks by adversarial samples).

Moreover, the regularization term may be determined to be smaller when the similarity is higher, and may be determined to be larger when the similarity is lower.

Accordingly, it is possible to prevent the first parameter used in a neural network from becoming a parameter likely to change the accuracy of an inferred value. As a result, it is possible to derive a neural network having robustness to a variation in input data of the neural network.

Moreover, the neural network derivation method further includes third regularization term training step S18 of training discriminator 41 for determining a regularization term, between first training step S10 and second training step S20. In third regularization term training step S18: the first input data and the second input data may be inputted to discriminator 41; and discriminator 41 may be trained using a third expected value calculated from fifth inferred value x and sixth inferred value G(z+Δz).

Accordingly, since discriminator 41 can be trained using the third expected value, it is possible to train the first neural network using, as the index, the second loss function including the regularization term determined by trained discriminator 41. As a result, it is possible to derive a neural network having robustness to a variation in input data.

Moreover, for the fifth inferred value, the third expected value may be always S, S being greater than 0, and for the sixth inferred value, the third expected value may be −S when the similarity is high compared to a preceding sixth inferred value in a time-series view of the sixth inferred value; and the third expected value may be 0 when the similarity is not high compared to the preceding sixth inferred value in the time-series view of the sixth inferred value.

Accordingly, it is possible to determine the third expected value appropriately and train discriminator 41 appropriately. For this reason, it is possible to train the first neural network using, as the index, the second loss function including the regularization term determined by trained discriminator 41. As a result, it is possible to derive a neural network having robustness to a variation in input data.

Moreover, in third regularization term training step S18, discriminator 41 may be trained using a fifth loss function having, as inputs, a fifth feature calculated based on the first input data and a sixth feature calculated based on the second input data.

Accordingly, since discriminator 41 can be trained appropriately, it is possible to train the first neural network using, as the index, the second loss function including the regularization term determined by trained discriminator 41. As a result, it is possible to derive a neural network having robustness to a variation in input data.

Moreover, the fifth loss function may be a triplet loss function, the fifth feature obtained in (N−1)th training may be set as a reference feature, N being greater than 1, the fifth feature obtained in Nth training may be set as a positive feature, and the sixth feature obtained in the Nth training may be set as a negative feature.

Accordingly, it is possible to train discriminator 41 appropriately, based on the fifth loss function. For this reason, it is possible to train the first neural network using, as the index, the second loss function including the regularization term determined by trained discriminator 41. As a result, it is possible to derive a neural network having robustness to a variation in input data.

Moreover, the first input data may be expressed by a third numeric representation, and the second input data may be expressed by a fourth numeric representation different from the third numeric representation.

Even when input data is converted from the third numeric representation to the fourth numeric representation, the neural network derivation method according to the present embodiment makes it possible to derive a neural network having robustness.

Moreover, the third numeric representation may be a real number consisting of a float value, and the fourth numeric representation may be an integer.

Even when the third numeric representation is a real number consisting of a float value and the fourth numeric representation is an integer, the neural network derivation method according to the present embodiment makes it possible to derive a neural network having robustness.

### Embodiment 4

### [4-1. Derivation Model for Deriving Neural Network]

A derivation model for deriving a neural network will be described in Embodiment 4. Specifically, in Embodiment 4, the following describes an example of generating a neural network having robustness to a variation in weight parameter.

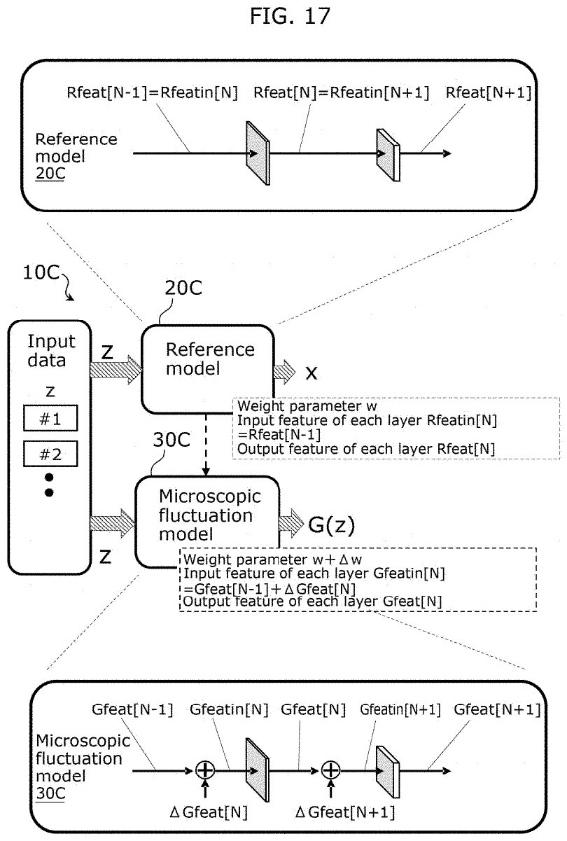

FIG. 17 is a diagram illustrating derivation model 10C for deriving a neural network in Embodiment 4. As shown by FIG. 17, derivation model 10C includes reference model 20C and microscopic fluctuation model 30C.

Reference model 20C includes a first neural network having weight parameter (first parameter) w. Input data (first input data) z is inputted to reference model 20C. Input data z is expressed by, for example, a third numeric representation such as a real number consisting of a float value. Reference model 20C, to which input data z is inputted, outputs inferred value (seventh inferred value) x as an output value. Machine learning is executed on reference model 20C based on a predetermined training data set including input data z. Reference model 20C includes layers. An output of each of the layers is denoted by Rfeat[N] as a feature, N being an index of the layer. Input feature Rfeatin[N] of each layer is equal to Rfeat[N−1].

Microscopic fluctuation model 30C includes a second neural network having a weight parameter (second parameter) obtained by adding microscopic fluctuation Δw to the same weight parameter w as that of reference model 20C. Input data (first input data) z is inputted to microscopic fluctuation model 30C, and inferred value (eighth inferred value) G(z) is outputted as an output value from microscopic fluctuation model 30C. Microscopic fluctuation model 30C and reference model 20C share weight parameter w, and weight parameter w of reference model 20C is updated by microscopic fluctuation model 30C being trained. Microscopic fluctuation model 30C includes layers. An output of each of the layers is denoted by Gfeat[N] as a feature, N being an index of the layer. Input feature Gfeatin[N] of each layer is obtained by adding microscopic fluctuation ΔGfeat [N] to Gfeat[N−1].

It should be noted that a feature outputted from each layer is originally a latent feature of a network. For this reason, the feature outputted from the layer is included in the latent feature of the network, and is substantially the same as the latent feature. Microscopic fluctuation model 30C has the same configuration as reference model 20C except the above-described weight parameter.

### [4-2. Neural Network Derivation Method]

The following describes a method of deriving a neural network using above-described derivation model 10C.

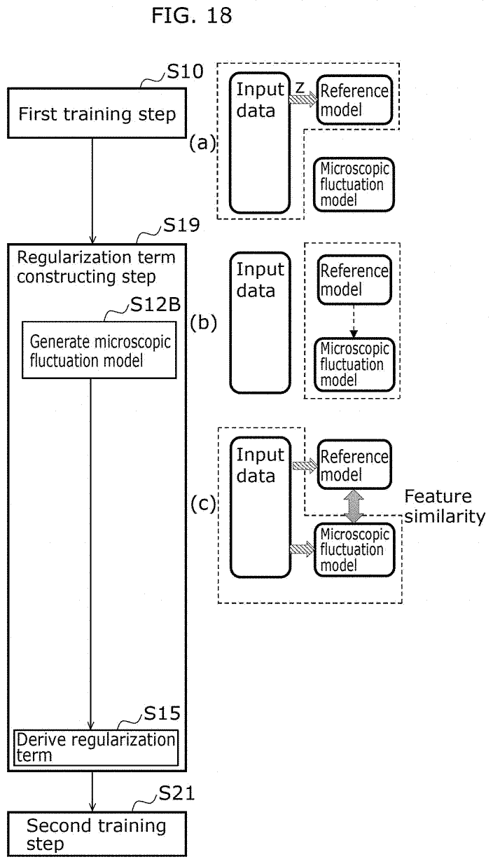

FIG. 18 is a flowchart illustrating a neural network derivation method according to Embodiment 4.

The neural network derivation method includes first training step S10, regularization term constructing step S19, and second training step S21.

First training step S10 is a step of training a first neural network of reference model 20C. First training step S10 is executed within the broken line indicated by (a) in FIG. 18. In this step, the first neural network is trained using a predetermined training data set, with a first loss function for optimization. First training step S10 calculates weight parameter w in the first neural network.

Regularization term constructing step S19 is a step of deriving a form different from the above-described regularization term. Regularization term constructing step S19 includes step S12B of generating microscopic fluctuation model 30C and step S15 of deriving a regularization term from reference model 20C and microscopic fluctuation model 30C.

Step S12B of generating microscopic fluctuation model 30C is a step of deriving a second neural network having a weight parameter obtained by adding microscopic fluctuation Δw to the same weight parameter w, based on the first neural network. Step S12B is executed within the broken line indicated by (b) in FIG. 18. A weight parameter is denoted by (w+Δw). Original weight parameter w is shared by reference model 20C.

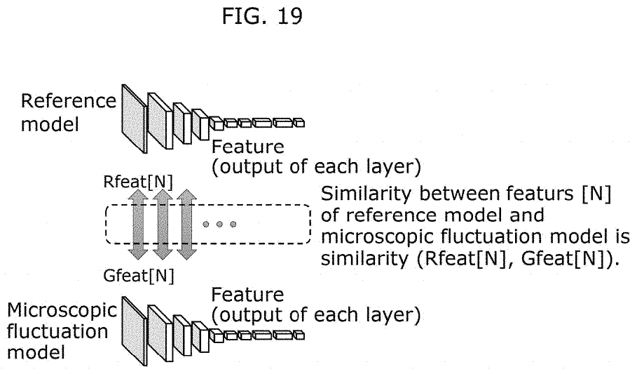

Step S15 of deriving a regularization term is executed in a branch indicated by (c) in FIG. 18. As shown by (c) in FIG. 19, a feature similarity between reference model 20C and microscopic fluctuation model 30C is calculated. FIG. 19 is a diagram illustrating the definition of a feature similarity in Embodiment 4. This figure shows outputs of each layer as features Rfeat[N] and Gfeat[N] in a reference model and a microscopic fluctuation model including layers, N being an index of the layer. The term “similarity” indicates a degree of similarity between Rfeat[N] and Gfeat[N]. The above-described cosine similarity is used as a similarity.

A regularization term is obtained by reversing a sign of a feature similarity of layer N according to weight parameter w[N] of each layer.

Second training step S21 is a step of training the first neural network using a second loss function (second loss function=first loss function+regularization term) for optimization obtained by adding a regularization term to the first loss function. Second training step S21 is executed within the broken line indicated by (c) in FIG. 18, and a predetermined training data set is used in second training step S21 in the same manner as first training step S10. Since original weight parameter w is shared by reference model 20C and microscopic fluctuation model 30C as stated above, second training step S21 updates weight parameter w of the first neural network.

### [4-3. Advantageous Effects Etc.]

As stated above, the neural network derivation method according to Embodiment 5 includes: first training step S10 of training a first neural network to which first input data (e.g., input data z) is inputted, using a first loss function for optimization; and second training step S21 of training the first neural network using a second loss function for optimization, after first training step S10, the second loss function being obtained by adding a regularization term to the first loss function. After a second neural network to which a second parameter (e.g., weight parameter (w+Δw), input data (z+Δz)) obtained by adding a variation to a first parameter based on the first neural network is derived or a second neural network having a feature (Gfeat[N−1]+ΔGfeat[N]) obtained by adding a variation to a feature of an output of each of layers of the first neural network is derived, the regularization term is determined based on a similarity between the feature of each layer of the first neural network and a feature of an output of each corresponding layer of the second neural network.

Accordingly, it is possible to calculate a regularization term based on a similarity between a feature (Rfeat) of the first neural network and a feature (Gfeat) of the second neural network, and train the first neural network using the second loss function for optimization including the regularization term. As a result, it is possible to derive a neural network having robustness to a variation in parameter of the neural network, without using the discriminator used in Embodiments 1, 2, and 3.

Moreover, the first parameter may be expressed by a third numeric representation, and the second parameter may be expressed by a fourth numeric representation different from the third numeric representation.

Even when a parameter is converted from the third numeric representation to the fourth numeric representation, the neural network derivation method according to the present embodiment makes it possible to derive a neural network having robustness.

Moreover, the third numeric representation may be a real number consisting of a float value, and the fourth numeric representation may be an integer.

Even when the third numeric representation is a real number consisting of a float value and the fourth numeric representation is an integer, the neural network derivation method according to the present embodiment makes it possible to derive a neural network having robustness.

Moreover, only a weight parameter (e.g., w+Δw) may vary in the second neural network.

Even when only a weight parameter varies in the second neural network, the neural network derivation method according to the present embodiment makes it possible to derive a neural network having robustness to the weight parameter.

Moreover, the neural network derivation method according to the present embodiment may be configured in the following manners.

For example, a neural network derivation method may include: a first training step of training a first neural network having a first parameter, using a first loss function for optimization; and a second training step of training the first neural network using a second loss function for optimization, after the first training step, the second loss function being obtained by adding a regularization term to the first loss function. After a second neural network having a second parameter obtained by adding a variation to the first parameter based on the first neural network is derived, the regularization term may be determined based on a correlation between a latent feature of the first neural network and a latent feature of the second neural network or a correlation between an inferred value of the first neural network and an inferred value of the second neural network. Moreover, the regularization term may be determined based on a similarity between (i) a feature of an output of at least one layer, other than a last layer, of the first neural network and (ii) a feature of an output of a layer of the second neural network corresponding to the at least one layer.

For example, a neural network derivation method may include: a first training step of training a first neural network having a first weight parameter, using a first loss function for optimization; and a second training step of training the first neural network using a second loss function for optimization, after the first training step, the second loss function being obtained by adding a regularization term to the first loss function. The regularization term may be determined based on a relationship between the first neural network and a second neural network having a second weight parameter obtained by adding a variation to the first weight parameter based on the first neural network.

For example, a neural network derivation method may include: a first training step of training a first neural network having a firster parameter, using a first loss function for optimization; and a second training step of training the first neural network using a second loss function for optimization, after the first training step, the second loss function being obtained by adding a regularization term to the first loss function. The regularization term may be determined based on a relationship between the first neural network and a second neural network based on the first neural network, and the second neural network may be based on the first neural network and further include a configuration in which an input of at least one layer is obtained by adding a variation to a feature that is an output of a preceding layer. It should be noted that the expression “at least one layer” need not mean all layers. To put it another way, the second neural network may be based on the first neural network and include a configuration in which each of inputs of some of layers is obtained by adding a variation to a feature that is an output of a preceding layer.

### OTHER EMBODIMENTS

Although the neural network derivation method according to the present disclosure has been described above based on each of the embodiments, the present disclosure is not limited to the aforementioned embodiments. Forms obtained by various modifications to each of the aforementioned embodiments that can be conceived by a person skilled in the art as well as other forms realized by combining a portion of the elements in each of the aforementioned embodiments are included in the scope of the present disclosure as long as they do not depart from the essence of the present disclosure.

Moreover, the following forms may be included in the scope of one or more aspects of the present disclosure.

(1) A portion of the elements included in the above-described acoustic signal processing device may be a computer system configured from a microprocessor, a read only memory (ROM), a random access memory (RAM), a hard disk unit, a display unit, a keyboard, and a mouse, for example. A computer program is stored in the RAM or the hard disk unit. Each device achieves its function as a result of the microprocessor operating according to the computer program. Here, the computer program is configured of a plurality of pieced together instruction codes indicating a command to the computer in order to achieve a given function.

(2) A portion of the elements of each of the above-described acoustic signal processing device and method may be configured from one system LSI (Large Scale Integration). A system LSI is a super-multifunction LSI manufactured with a plurality of components integrated on a single chip, and is specifically a computer system configured of a microprocessor, ROM, and RAM, for example. A computer program is stored in the RAM. The system LSI achieves its function as a result of the microprocessor operating according to the computer program.

(3) A portion of the elements included in the above-described acoustic signal processing device may each be configured from a detachable IC card or a stand-alone module. The IC card and the module are computer systems configured from a microprocessor, ROM, and RAM, for example. The IC card and the module may include the super-multifunction LSI described above. The IC card and the module achieve their function as a result of the microprocessor operating according to a computer program. The IC card and the module may be tamperproof.

(4) Moreover, a portion of the elements included in the above-described derivation device may also be implemented as the computer program or the digital signal recorded on recording media readable by a computer, such as a flexible disk, hard disk, a compact disc (CD-ROM), a magneto-optical disc (MO), a digital versatile disc (DVD), DVD-ROM, DVD-RAM, a Blu-ray (registered trademark) disc (BD), or a semiconductor memory, for example. The present disclosure may also be the digital signal recorded on the aforementioned recoding media.

>Furthermore, a portion of the elements included in the above-described derivation device may be the aforementioned computer program or the aforementioned digital signal transmitted via an electrical communication line, a wireless or wired communication line, a network represented by the Internet, data broadcasting, or the like.

(5) The present disclosure may be a method shown above. Moreover, the present disclosure may also be a computer program implementing these methods with a computer, or a digital signal of the computer program.

(6) Furthermore, the present disclosure may be a computer system including a microprocessor and a memory. The memory may store the aforementioned computer program and the microprocessor may operate according to the computer program.

(7) Moreover, by transferring the aforementioned recording medium having the aforementioned program or digital signal recorded thereon or by transferring the aforementioned program or digital signal via the aforementioned network or the like, the present disclosure may be implemented by a different independent computer system.

(8) It is also acceptable to combine the above embodiments and the above variations.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to, as a method of implementing a neural network in a computer etc., an image processing method, a voice recognition method, an object control method, etc.

1. A neural network derivation method, comprising:
(1) training a first neural network having a first parameter, using a first loss function for optimization; and
(2) training the first neural network using a second loss function for optimization, after (1), the second loss function being obtained by adding a regularization term to the first loss function,
wherein after a second neural network having a second parameter obtained by adding a variation to the first parameter based on the first neural network is derived, the regularization term is determined based on a correlation between a latent feature of the first neural network and a latent feature of the second neural network or a correlation between an inferred value of the first neural network and an inferred value of the second neural network.

2. A neural network derivation method, comprising:
(1) training a first neural network having a first weight parameter, using a first loss function for optimization; and
(2) training the first neural network using a second loss function for optimization, after (1), the second loss function being obtained by adding a regularization term to the first loss function,
wherein the regularization term is determined based on a relationship between the first neural network and a second neural network having a second weight parameter obtained by adding a variation to the first weight parameter based on the first neural network.

3. A neural network derivation method, comprising:
(1) training a first neural network having a first parameter, using a first loss function for optimization; and
(2) training the first neural network using a second loss function for optimization, after (1), the second loss function being obtained by adding a regularization term to the first loss function,
wherein the regularization term is determined based on a relationship between the first neural network and a second neural network based on the first neural network, and
the second neural network is configured based on the first neural network and further includes a configuration in which an input of at least one layer is obtained by adding a variation to a feature that is an output of a preceding layer.

4. The neural network derivation method according to claim 1,
wherein the regularization term is determined based on a time-series variation in similarity between a first inferred value of the first neural network and a second inferred value of the second neural network.

5. The neural network derivation method according to claim 1,
wherein the regularization term is determined based on a similarity between (i) a feature of an output of at least one layer, other than a last layer, of the first neural network and (ii) a feature of an output of a layer of the second neural network corresponding to the at least one layer.

6. The neural network derivation method according to claim 4, further comprising:
(3) training a discriminator for determining the regularization term, between (1) and (2),
wherein in (3):
the first parameter and the second parameter are inputted to the discriminator; and
the discriminator is trained using a first expected value calculated from the first inferred value and the second inferred value.

7. The neural network derivation method according to claim 6,
wherein for the first inferred value, the first expected value is always S, S being greater than 0, and
for the second inferred value, the first expected value is −S when the similarity is high compared to a preceding second inferred value in a time-series view of the second inferred value; and the first expected value is 0 when the similarity is not high compared to the preceding second inferred value in the time-series view of the second inferred value.

8. The neural network derivation method according to claim 6,
wherein in (3), the discriminator is trained using a third loss function having, as inputs, a first feature calculated based on the first parameter and a second feature calculated based on the second parameter.

9. The neural network derivation method according to claim 8,
wherein the third loss function is a triplet loss function,
the first feature obtained in (N−1)th training is set as a reference feature, N being greater than 1,
the first feature obtained in Nth training is set as a positive feature, and
the second feature obtained in the Nth training is set as a negative feature.

10. The neural network derivation method according to claim 4,
wherein the first parameter is expressed by a first numeric representation, and
the second parameter is obtained by converting the first parameter into a second numeric representation.

11. The neural network derivation method according to claim 10,
wherein the first numeric representation is a real number consisting of a float value, and the second numeric representation is an integer, and
the second parameter is obtained by quantizing the first parameter.

12. The neural network derivation method according to claim 4, further comprising:
(4) training a discriminator for determining the regularization term, between (1) and (2),
wherein in (4):
first input data and second input data are inputted to the discriminator; and
the discriminator is trained using a second expected value calculated from (i) a third inferred value of the first neural network when the first input data is inputted to the first neural network and (ii) a fourth inferred value of the second neural network when the second input data is inputted to the second neural network, the second input data being obtained by adding a variation to the first input data.

13. The neural network derivation method according to claim 12,
wherein for the third inferred value, the second expected value is always S, S being greater than 0, and
for the fourth inferred value, the second expected value is −S when the similarity is high compared to a preceding fourth inferred value in a time-series view of the fourth inferred value; and the second expected value is 0 when the similarity is not high compared to the preceding fourth inferred value in the time-series view of the fourth inferred value.

14. The neural network derivation method according to claim 13,
wherein in (4), the discriminator is trained using a fourth loss function having, as inputs, (i) a third feature calculated based on the first parameter and the first input data and (ii) a fourth feature calculated based on the second parameter and the second input data.

15. The neural network derivation method according to claim 14,
wherein the fourth loss function is a triplet loss function,
the third feature obtained in (N−1)th training is set as a reference feature, N being greater than 1,
the third feature obtained in Nth training is set as a positive feature, and
the fourth feature obtained in the Nth training is set as a negative feature.

16. The neural network derivation method according to claim 12,
wherein the first input data is expressed by a third numeric representation, and
the second input data is expressed by a fourth numeric representation different from the third numeric representation.

17. The neural network derivation method according to claim 16,
wherein the third numeric representation is a real number consisting of a float value, and the fourth numeric representation is an integer

18. A neural network derivation method, comprising:
(1) training a first neural network to which first input data is inputted, using a first loss function for optimization; and
(2) training the first neural network using a second loss function for optimization, after (1), the second loss function being obtained by adding a regularization term to the first loss function,
wherein after a second neural network to which second input data obtained by adding a variation to the first input data based on the first neural network is inputted is derived, the regularization term is determined based on a time-series variation in similarity between a fifth inferred value of the first neural network and a sixth inferred value of the second neural network.

19. The neural network derivation method according to claim 18,
wherein the regularization term is determined to be smaller when the similarity is higher; and the regularization term is determined to be larger when the similarity is lower.

20. The neural network derivation method according to claim 19, further comprising:
(5) training a discriminator for determining the regularization term, between (1) and (2),
wherein in (5):
first input data and second input data are inputted to the discriminator; and
the discriminator is trained using a third expected value calculated from the fifth inferred value and the sixth inferred value.

21. The neural network derivation method according to claim 20,
wherein in (5), the discriminator is trained using a fifth loss function having, as inputs, a fifth feature calculated based on the first input data and a sixth feature calculated based on the second input data.
